(19) United States
(12) Patent Application Publication
(10) Pub. No.: US 2009/0047506 A1
(43) Pub. Date: Feb. 19, 2009

(54) LAMINATED GLASS AND ELECTRONIC DEVICE USING SAME FOR DISPLAY SCREEN THEREOF

(75) Inventors: YING-CHANG JIANG, Shenzhen (CN); LING-DONG XIANG, Shenzhen (CN); CHIA-HSING CHANG, Shindian (TW); PENG LU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/961,301

(22) Filed: Dec. 20, 2007

(30) Foreign Application Priority Data
Aug. 17, 2007 (CN) 200710076407.2

(51) Int. Cl. B32B 17/06

(52) U.S. Cl. 428/332; 428/426

(57) ABSTRACT

A piece of laminated glass is provided. The laminated glass includes a first glass layer (12), a second glass layer (16), and an interlayer (14). The interlayer is located between the first glass layer and the second glass layer. The interlayer is integrally formed with the first glass layer and the second glass layer as a whole. The interlayer is made of Acrylate material.

### BACKGROUND OF THE INVENTION

1. Field of the Invention

The present invention relates to a piece of laminated glass with a relatively high light-transmitting quality, and an electronic device using the laminated glass for a display screen thereof.

2. Description of Related Art

Laminated glass is a type of safety glass that holds together when shattered. In event of shattering, the laminated glass is held in place by an interlayer, typically of polyvinyl butyral (PVB), between its two or more layers of glass. The interlayer keeps the layers of glass bonded even when broken, and its high strength prevents the glass from shattering into sharp pieces. This produces a characteristic “spider web” cracking pattern when the strength of the impact is not enough to completely shatter the glass.

Due to safety reasons, laminated glass is normally used when there is a possibility of human impact or where shattered glass could fall as the glass is shattered. The laminated glass could also be applied for displaying, i.e., acting as a display screen of an electronic device (e.g., a mobile phone). However, as the interlayer (usually of PVB) lack of high light-transmitting quality, the displaying effect of the laminated glass, as well as that of the display screen, can inevitably be worsened by the PVB interlayer.

Therefore, a heretofore-unaddressed need exists in the art to address the aforementioned deficiencies and inadequacies.

### SUMMARY

In present aspect, a piece of laminated glass is provided. The laminated glass includes a first glass layer, a second glass layer, and an interlayer. The interlayer is located between the first glass layer and the second glass layer. The interlayer is integrally formed with the first glass layer and the second glass layer as a whole. The interlayer is of Acrylate material.

In another aspect, an electronic device is provided. The electronic device includes a housing and a display screen. The display screen is mounted on the housing. The display screen includes at least one piece of laminated glass. Each laminated glass includes a first glass layer, a second layer, and an interlayer. The interlayer is located between the first glass layer and the second glass layer and integrally formed with the first glass layer and the second glass layer as a whole. The interlayer is made of Acrylate material.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present laminated glass and the present electronic device using same for a display screen thereof can be better understood with reference to the following drawings. These drawings are not necessarily drawn to scale, the emphasis instead being placed upon clearly illustrating the principles of the present laminated glass and the present electronic device using same for a display screen thereof. Moreover, in the drawings like reference numerals designate corresponding parts throughout the several views. Wherever possible, the same reference numbers are used throughout the drawings to refer to the same or like elements of an embodiment.

FIG. 1 is a planar view of an electronic device, applying a piece of laminated glass for a display screen thereof, in accordance with a present embodiment; and

FIG. 2 is a cut-away view of the laminated glass shown in FIG. 1.

### DETAILED DESCRIPTION OF THE EMBODIMENTS

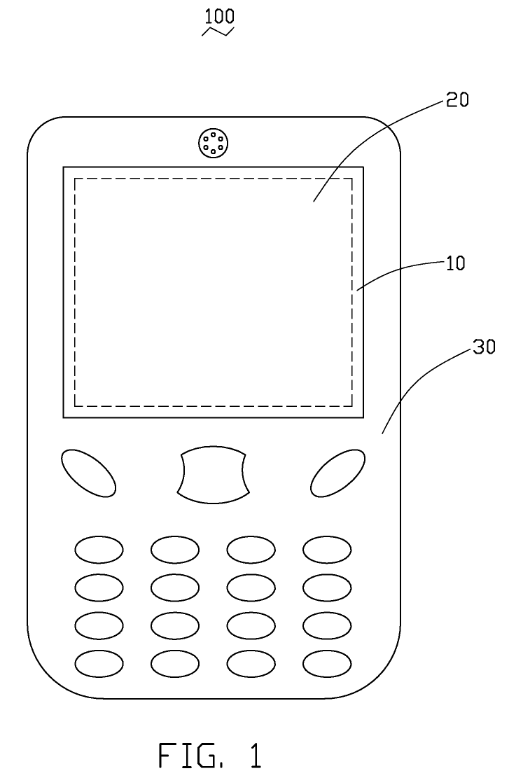

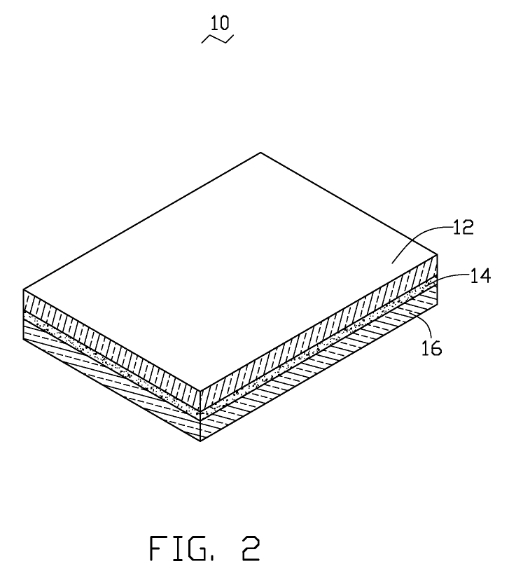

The present electronic device using a piece of laminated glass for a display screen thereof is described here in conjunction with the accompanying drawings in FIGS. 1 and 2. The electronic device can be one of a mobile phone, a personal digital handset, and other electronic devices respectively configured with a display screen. A mobile phone is exemplified as an embodiment to illustrate principles of the present laminated glass and the present electronic device using the laminated glass for a display screen thereof.

Referring to FIG. 1 in detail, the mobile phone 100 includes a display assembly (not labeled) and a housing 30. The display assembly includes a display screen 10 and a display module 20. The display assembly can be assembled/mounted (e.g., screwed, or adhered) with the housing 30, in which the display screen 10 can be mounted on the housing 30 and the display module 20 can be mounted within the housing 30. Lights, emitted from the display module 20, penetrate through the display screen 10 so as to display an image/figure in the display screen 10.

Referring further to FIG. 2, the display screen 10 is a piece of laminated glass. It is understood that the display screen 10 may include one more pieces of the laminated glass, which are held together by such methods as adhering or bonding. The display screen 10 (i.e., the laminated glass) includes a first glass layer 12, an interlayer 14, and a second glass layer 16. The interlayer 14 is located between the first and second glass layers 12 and 16. The first and second glass layers 12 and 16, and the interlayer 14 are integrated as one.

The first and second glass layers 12 and 16 can respectively be provided with any thickness. The first and second glass layers 12 and 16 are advantageously of 0.4 mm through 0.5 mm. The first and second glass layers 12 and 16 can respectively be one of a simple glass or a reinforced glass (e.g., an annealed simple glass or a chemical-reinforced glass).

The interlayer 14 is made of Acrylate material. Thickness of the interlayer 14 is configured (e.g., structured/ arranged) for facilitating an effective and sufficient bonding of the interlayer 14 with the first and second glass layers 12 and 16 and a relatively high light-transmitting quality of the display screen 10. The thickness of the interlayer 14 is advantageously at least 0.02 mm for effectively and sufficiently bonding with the first and second glass layers 12 and 16. With the increasing of the interlayer's 14 thickness, the light-transmitting quality of the display screen 10 is inevitably lowered. The thickness of the interlayer 14 may further be advantageously limited not more than 0.1 mm for achieving/maintaining a relatively high light-transmitting quality. Thus, the thickness of the interlayer 14 is ranged from 0.02 mm to 0.1 mm. In the present embodiment, the interlayer's 14 thickness can advantageously be of 0.02 mm-0.05 mm.

It is understood that the laminated glass for the display screen 10 can instead be manufactured by bonding two more layers of glasses together with at least one interlayer 14. Each adjacent two glass layers has one interlayer 14 bonded therebetween.

One main advantage of the present embodiment embodies that the interlayer 14 of the display screen 10 can be almost colorless and transparent for Acrylate material thereof and the thickness thereof being less than 0.1 mm. The display screen 10 can thus achieve a relatively high light-transmitting quality.

Another main advantage of the present embodiment is that the laminated glass combined with the display screen 10 is safe. In event of breaking, the laminated glass is held in place by the interlayer 14, of Acrylate, between the first and second glass layers 12 and 16. The interlayer 14 further keeps the glass layers 12 and 16 bonded even when broken, and its high strength prevents the laminated glass from shattering into sharp pieces.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A piece of laminated glass, comprising:
a first glass layer;
a second glass layer; and
an interlayer located between the first glass layer and the second glass layer and integrally formed with the first glass layer and the second glass layer as a whole, the interlayer made of Acrylate material, the interlayer having a thickness of 0.02 mm-0.1 mm.

2. The laminated glass as claimed in claim 1, wherein the thickness of the interlayer is in a range of 0.02 mm -0.05 mm.

3. The laminated glass as claimed in claim 1, wherein the interlayer is bonded with the first glass layer and the second glass layer.

4. The laminated glass as claimed in claim 1, wherein each of the first glass layer and the second glass layer is selected from one of a simple glass and a reinforced glass.

5. The laminated glass as claimed in claim 1, wherein each of the first glass layer and the second glass layer is 0.4 mm-0.5 mm thick.

6-9. (canceled)

10. An electronic device, comprising:
a housing; and
a display screen mounted on the housing, the display screen comprising at least one piece of laminated glass, each laminated glass including a first glass layer, a second layer, and an interlayer, the interlayer being located between the first glass layer and the second glass layer and integrally formed with the first glass layer and the second glass layer as a whole, the interlayer made of Acrylate material, the interlayer having a thickness of 0.02 mm-0.1 mm.

11. The laminated glass as claimed in claim 10, wherein the thickness of the interlayer is of 0.02 mm-0.05 mm.

12. The laminated glass as claimed in claim 10, wherein the interlayer is bonded with the first glass layer and the second glass layer.

13. The laminated glass as claimed in claim 10, wherein each of the first glass layer and the second glass layer is one of a simple glass and a reinforced glass.

14. The laminated glass as claimed in claim 10, wherein each of the first glass layer and the second glass layer is 0.4 mm-0.5 mm thick.
